(19) United States
(12) Patent Application Publication
(10) Pub. No.: US 2019/0019394 A1
(43) Pub. Date: Jan. 17, 2019

(54) B764 School Bus Airline Transportation Bracelet

(71) Applicant: Valentino King, Raleigh, NC (US)

(72) Inventor: Valentino King, Raleigh, NC (US)

(21) Appl. No.: 15/652,186

(22) Filed: Jul. 17, 2017

(51) Int. Cl. G08B 21/02; G08B 13/196

(52) U.S. Cl. CPC G08B 21/0208; G08B 13/1966; G08B 21/0286; G08B 21/0269

(57) ABSTRACT

The present invention relates to improvements in passenger safety, particularly with the creation of an alert and monitoring bracelet. There is no known system in which a multi-passenger vehicle alerts the appropriate authorities automatically in the event of an emergency or missing passenger. The present invention discloses a triple waterproof ID bracelet, stationary laptop (1), weapon and ID scanner (1), and security cameras (4).

### TECHNICAL FIELD

The present invention generally relates to creating a monitoring and alert bracelet for the transportation industry.

### BACKGROUND OF THE INVENTION

The primary purpose of this bracelet is to act as an electronic medical alert, tracking and monitoring device individuals while in transit. The alert system will save countless lives through the transmission of real time identifying, medical, travel and location information. Furthermore, it will help improve the amber alert and silver alert systems for faster tracking of the location of the missing individual.

### SUMMARY OF THE INVENTION

B764 School Bus Airline Transportation Bracelet relies on several major components including a stationary laptop, scanner, The ID bracelet and security cameras that seamlessly work together to notify the appropriate assigned personnel of the passenger headcount, whether or not the passengers are carrying weapons on their person or if they have any medical issues that the authorities should be made aware of.

### DETAILED DESCRIPTION OF THE INVENTION

The ID Bracelet

The Safety ID Bracelet is a programmable triple waterproof bracelet that stores up to 6 functions or pieces of information.

For airlines the bracelet can be used as a ticket and will have the following digital panels.

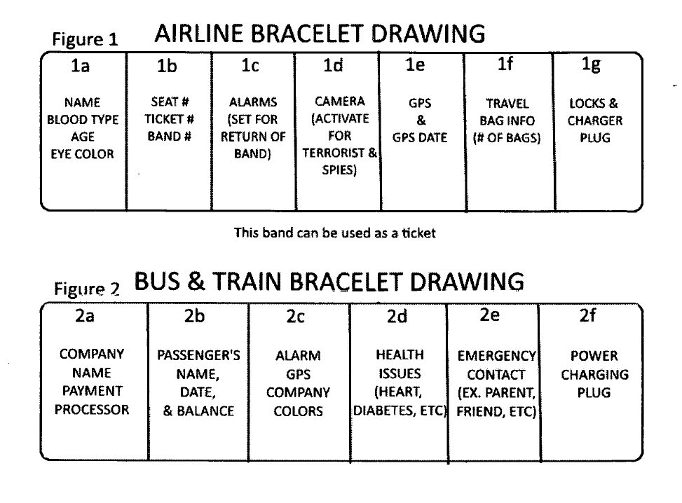

FIG. 1 Airline Bracelet Drawing View
1a. Passenger ID panel providing the name of the passenger, their blood type, age and eye color.
1b. Trip Info panel with the seat number, ticket number, band number and a sign.
1c. Alarm panel with a built in alarm to set reminder for return of band.
1d. Camera activation panel for terrorism and spies
1e. Tracking panel with an embedded 3000 mile radius GPS tracking system that will be able to locate missing passengers (that will work with amber and silver alerts).
1f. Baggage Info panel
1g. Locks and charger outlet

FIG. 2 Bus & Train Bracelet Drawing View

For buses and trains the bracelet will have the following digital panels:
2a. Company info panel providing the name of the transport company and payment processor
2b. Passenger's info panel with the name, address, travel date and balance info
2c. Alarm panel with an embedded 3000 mile radius GPS tracking system that will be able to locate missing passengers (that will work with amber and silver alerts), a built in alarm and a travel reminder voice feature that will announce to the passenger their travel plans like bus number or gate info. It will also have the company color code.
2d. Health panel with health information such as allergies, asthma, diabetes, heart conditions, etc.
2e. Emergency contact panel with contact info for parents (if child passenger) or other contact info.
2f. Charger outlet

### The Laptop

Each passenger vehicle will have a stationary laptop that will contain the passenger list, a scanner reader program, software that will communicate with the regulators and law enforcement, and the feed from the security cameras. The operator's responsibility will be to activate the system prior to each trip by signing in.

### The Scanner

Once the system is active, each passenger will present their ID bracelets to the scanner (or enter a 4 digit pin code) as they board. The scanner will then proceed to scan the passenger's bracelet, body and belongings simultaneously looking for route information and whether or not the passenger has weapons. The system will automatically update itself with this information and will immediately transfer this information to the predetermined location, depending upon type of transport. For example, for school buses, the data will be transmitted to the school. For public transportation vehicles, the data will be transmitted to the station or airport the passenger is heading to.

If discrepancies with the passenger headcount or weapons are found, the appropriate personnel and/or authorities will be notified immediately.

### Security Cameras

Each passenger vehicle will have 4 security cameras installed on it, one at each corner of the vehicle. The cameras will record all activities taking place on the vehicle on at all times, thus minimizing possibility for horseplay, bullying, sexual harassment/assault and fighting. The feed from the security cameras will be stored on the stationary laptop.

1. A passenger vehicle security system comprising:
1. a laptop
2. a scanner
3. a security camera (4)
The laptop in claim I characterized in that it is physically connected to the vehicle and contains the data and communication software that will be transmitted to the appropriate authorities.
The scanner in claim I characterized in that it scans the bracelet, personal belongings and body of passengers verifying their identity and travel information while simultaneously searching for weapons.
The security camera in claim I characterized in that it contains the security feed and software that communicates with the predefined personnel, police, EMS and fire department.

2. Programmable ID Bracelet comprising:
1. memory software
2. GPS tracker
3. alarm & voice reminder
4. triple waterproof
5. charging plugs
The memory software in claim II characterized in that it that stores up to 7 functions or pieces of information including but not limited to passengers contact info, medical alert information, and travel details.
The scanner in claim II characterized in that it has a GPS tracking device that will be able to locate missing passengers. This feature will also electronically alert the amber alert system.
The alarm feature in claim II characterized in that it will act as another layer of defense or protection for missing children due to the alarming sound it emits when improperly deactivate (or tampered with).
The voice reminder in claim II characterized in that it will be programmed to remind the student of their bus assignment, or passenger of their gate assignment or reminder to return bracelet.
The triple waterproof feature in claim II characterized in that it will protect the ID bracelet from water damage in the event the bracelet gets wet or becomes submerged in water.
The charging feature in claim II characterized in that it will allow the wearer to recharge the bracelet so that it will be able to continue to offer travel safety and monitoring features.
